(19) United States
(12) Patent Application Publication
(10) Pub. No.: US 2014/0014024 A1
(43) Pub. Date: Jan. 16, 2014

(54) Flag Retention Clips

(71) Applicant: Joan Schroeder, Colombus Grove, OH (US)

(72) Inventor: Joan Schroeder, Colombus Grove, OH (US)

(21) Appl. No.: 13/937,334

(22) Filed: Jul. 9, 2013

Related U.S. Application Data
(60) Provisional application No. 61/669,808, filed on Jul. 10, 2012.

(51) Int. Cl. G09F 17/00

(52) U.S. Cl. CPC G09F 17/00
USPC 116/173

(57) ABSTRACT

A flag retention device is provided for stabilizing flags. The device includes a cuff with a pair of gripping tongues extending from an open portion thereof. To install the device on a flag pole, the gripping tongues are pried apart and the cuff opening is slid onto the pole. The fabric material of a flag is then placed between the gripping tongues, which exert force upon each other, securing the flag therebetween and in place. An alternative embodiment of the device includes a spring release. The spring release includes two extrusions extending from an opposing side of the cuff from the gripping tongues. Compression of the extrusions together forces the gripping tongues apart allowing easy installation of the device on a flagpole.

### CROSS REFERENCE TO RELATED APPLICATION

This application claims the benefit of U.S. Provisional Application No. 61/669,808 filed on Jul. 10, 2012, entitled “Garden Flag Clips.” The patent application identified above is incorporated here by reference in its entirety to provide continuity of disclosure.

### BACKGROUND OF THE INVENTION

1. Field of the Invention

The present invention relates to a garden décor accessory. More specifically, it relates to a clip that retains a fabric outdoor décor item. Flags are commonly used on the exterior of homes and in lawns and gardens, but the proper display of these items is subject to environmental conditions. The present clips provide a cuff that surrounds a pole and pinches a portion of a flag between two gripping tongues. By securing a number of these clips to various perimeter positions on a flag, decorators can ensure that the decorative item is maintained in a taught, unflappable position.

Flags and other fabric décor items are commonly used to adorn the exterior of homes as well as the surrounding curettage. Areas such as gardens, flower beds, and lawn edges are popular repositories for brightly colored décor. Flowers, birds, Americana, political messages, and picture prints are an example of some of the many types of design depicted on outdoor flags. Because of the wide variety in depictions, shapes, and sizes of flags, users are able to express their interests, associations, and hobbies in an aesthetically pleasing fashion.

Fabric decorations displayed outdoors must be anchored to a permanent fixture or rigid object. Because flags, tassels, pennants, and other fabric outdoor décor are lightweight and flexible, they can easily be blown around by wind gusts. If not properly anchored the decorative item may be blown away into the street or a neighboring yard during strong wind gusts. To address this problem, the decorator usually installs a flag pole and affixes the decorative item thereto.

Current flag anchoring systems are insufficient for maintain a fabric decorative item in an untangled configuration because they only restrict the movement of one side of the fabric. Thus all other parts of the decorative item are left to freely blow in the wind. Strong winds can wrap the decorative item around the flag pole, making it hard to see the displayed design and possibly resulting in damage to the fabric. An effective solution for restricting the movement of multiple edges of a fabric decorative item is need.

2. Description of the Prior Art

The present invention is versatile decorative fabric retention clip. It is ideally suited for use with garden flags but can be employed with a variety of decorative fabric displays. The device has a cylindrical cuff with an opening along one portion of the perimeter, from which extends two gripping tongues. The tensile strength of the device maintains the two gripping tongues in tight abutment until they are pulled apart. In use the cuff is affixed to a flagpole or other fixed structure, and the gripping tongues are placed on either side of a fabric sheet. An alternative embodiment of the device has a pair of spring-actuated extrusions disposed on the side of the cuff opposing the opening. When the extrusions are pressed together, the gripping tongues and opening are pried apart, making installation easy. The following prior art is a list of devices deemed relevant to the present disclosure.

Flag retention devices are available in a variety of styles and sizes. Spring actuated clips such as that described in Van Horn, U.S. Pat. No. 7,086,346 are sometimes used to hang a flag from a flag pole or stand. The Van Horn device is a laterally wide clip that clips on over the top of a T-shaped flag pole. The cross bar of the flagpole fits between the pinching jaws of the clip, which also grips the upper edge of a garden flag. Flags displayed by this means are free to blow in the breeze because they are only restrained along their uppermost edge.

Long, U.S. Pat. No. 7,421,972 also discloses a spring actuated clamp. The Long patent includes a flagpole with T-bar style banner extension and a clamp. This clamp is a clothespin with an exterior façade shaped like a butterfly. The clothespin clamp is placed on the end of the banner pole to prevent a flag wrapped around the banner pole from sliding off the pole. The long device requires flags to have a sleeve disposed along an upper edge for receiving the banner pole. Neither long nor Van Horn discloses a cuff that encircles a flag pole and clasps a flag thereto. The present invention has a snuggly fitting structure that encircles the flagpole and tightly holds the fabric of a flag in place.

Other devices retain a side portion of the flag rather than the upper portion. Nina, U.S. Pat. No. 5,975,009 discloses a wire triangle that is wound into small spring at one vertex. The interior of the spring is slid down over a flag pole to secure the device in place. The other two vertices of the triangle form pinching arms that meet and engage at one of the vertices. Small hooks disposed at the termination of the arms facilitate this engagement. This invention requires that holes be disposed along a lateral edge of the flag for receiving the pinching arms of the device. Unlike the Nina invention, the present invention grips and retrains the fabric of a flag without requiring holes in the fabric.

Like the Nina device, Blune, U.S. Pat. No. 4,852,733 discloses a wire flag retention device having a generally triangular shape. One vertex is coiled into a spring and adapted to receive the diameter of a flag pole. Two of the sides form an arm that meets at a terminus with the terminus of the third side. The arm is inserted through a hole in the side of a flag. In use, the flag can hang loosely from these fasteners. The present invention does not require holes, sheathes, sleeves, or medications of any kind to the flag itself, but can be used with any fabric décor.

These prior art devices have several known drawbacks. None of these devices disclose a cuff that encircles a flag pole nor do they disclose a pair of gripping tongues that clasp fabric therebetween. The present invention provides these structural elements and does not require any modification to the fabric it grasps. It substantially diverges in design elements from the prior art and consequently it is clear that there is a need in the art for an improvement to existing flag retention devices. In this regard the instant invention substantially fulfills these needs.

### SUMMARY OF THE INVENTION

In view of the foregoing disadvantages inherent in the known types of flag retention devices now present in the prior art, the present invention provides a new support cuff and gripping tongues wherein the same can be utilized for providing convenience for the user when retaining a portion of a fabric décor item

The present invention is a fabric décor retention device. It comprises a rigid cuff with an open slot at one portion of its perimeter. This cuff is installed around a flagpole by prying apart the opening and sliding the cuff around the circumference of the pole. Cuffs are provided in a variety of shapes and sizes to facilitate a snug fit between the device and the support it encircles. A pair of gripping tongues extends from either side of the opening along the cuff exterior. Interior edges of these tongues firmly abut when in a closed position.

In use the gripping tongues are opened, and manipulated into position on opposing sides of a sheet of fabric or paper. The rigid cuff exerts force on the gripping tongues, pushing them toward one another, thereby gripping the fabric or paper material between the tongues. Multiple cuffs may be used, along different support structures, to securely retain edges of a décor item such as a lawn flag.

An alternative embodiment of the invention has a spring actuated clamp formed from part of the cuff. Two extrusions extend from a portion of the cuff opposing the perimeter portion of the cuff having the opening. A spring is operatively connected to the junction of the two extrusions, such that depressing the extrusions towards one another results in opening of the cuff opening. In this way, the clamp mechanism provides an easy way to open and close the cuff around a flagpole or other support structure.

It is therefore an object of the present invention to provide a new and improved flag retention device that has all of the advantages of the prior art and none of the disadvantages.

It is therefore an object of the present invention to provide an easy to install means of retaining outdoor décor items such as flags and posters.

Another object of the present invention is to provide a flag retention device that can be placed along nay portion of a beam-like support structure and therefore can retain any portion of a flag perimeter.

Yet another object of the present invention is to provide a device that is capable of retaining multiple edges of a flag perimeter, thus preventing the flag from winding around a support structure during wind gusts.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of one embodiment of the flag retention device. The embodiment shown has a spring actuated clamp disposed on one side to facilitate easy opening and closing of the cuff.

FIG. 1B shows a perspective view of an embodiment of the device. This embodiment provides a basic cuff and gripping tongues for holding a flag perimeter edge.

FIG. 2 is a cross section view of the spring actuated clamp embodiment of the device.

FIG. 3 is a perspective view of the basic embodiment of the present invention in use. The cuff of the device is secured to a flagpole while the flag itself held in place by the gripping tongues.

### DETAILED DESCRIPTION OF THE INVENTION

Reference is made herein to the attached drawings. Like reference numerals are used throughout the drawings to depict like or similar elements of the flag retention device. For the purposes of presenting a brief and clear description of the present invention, the preferred embodiment will be discussed as used for retaining perimeter portions of outdoor decorative items. The figures are intended for representative purposes only and should not be considered to be limiting in any respect.

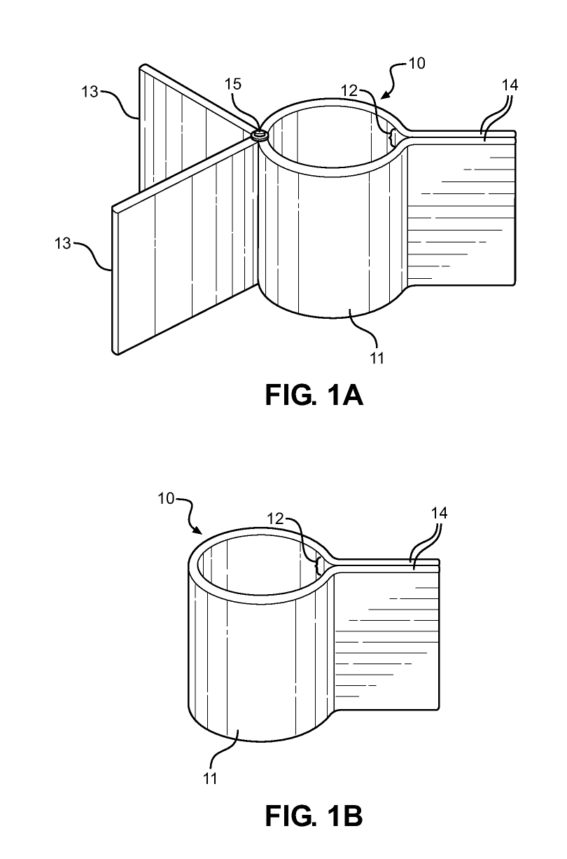

Referring now to FIG. 1B, there is shown a basic embodiment of the present invention. The flag retention device 10 comprises a cylindrical cuff 11 and a pair of gripping tongues 14. These tongues extend outward from the cuff on either side of an opening 12 in the cuff perimeter. The opening is a discontinuity in the cuff wall, separating a portion thereof into two abutting wall sections. Because the cuff is formed from a rigid material, the opening is maintained in a closed stated with the separate portions in tight abutment, unless pried apart. Similarly, the gripping tongues are maintained in tight abutment until pulled or wedged apart. Users can pull the tongues apart to increase the opening size until it is wide enough to receive a support structure such as a flagpole. Once the cuff is in place around the support structure, the tongues are released, resulting in the closure of the opening.

Referring now to FIG. 1A, there is shown a perspective view of a secondary embodiment of the flag retention device. This embodiment of the device 10 is similar to the basic in that it has a cuff 11 with a single opening 12 and a pair of gripping tongues 13. In addition to these components, this embodiment includes a spring actuated clamp. The clamp is formed from a pair of extrusions 13 positioned at an angle of less than 180 degrees from each other. A spring 15 is operatively connected to the extrusions and cuff. When the extrusions are pressed together the spring acts on the cuff wall, increasing the opening width. In this way, the alternative embodiment provides a mechanism for opening and closing the cuff of the device, thereby facilitating easy installation of the device on a support structure.

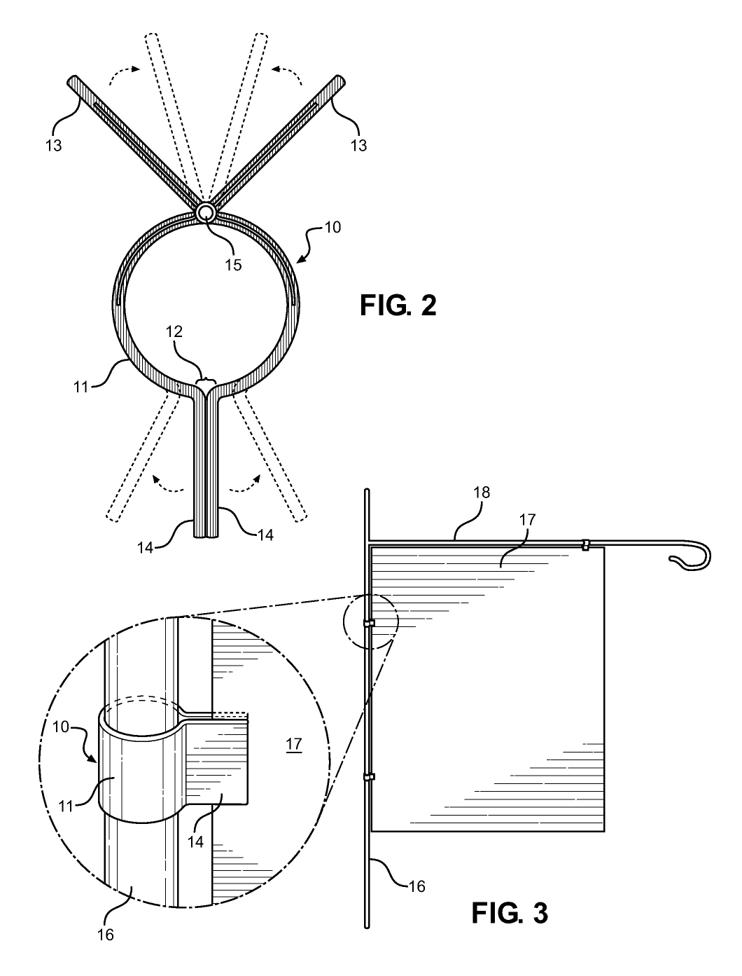

Basic operation of the secondary embodiment is shown in the cross-section of FIG. 2. The cuff 11 of the flag retention device 10 is cylindrical, but may have other geometrical shapes according to manufacturing needs. For example, square and octagonal cross-sections are also contemplated for use with common outdoor support structures. An opening 12 in the cuff facilitates widening of the cuff interior diameter and provides an insertion point for other objects. Each side of the opening has a gripping tongue 14 extending therefrom. The tongues are flat panel-like extrusions that abut along each interior surface when the device is in a closed position. When the opening is opened, the gripping tongues are spread apart.

A pair of extrusions and a spring form a clamp that affects opening and closing of the cuff opening. These extrusions 14 are flat panels having the same width as the cuff wall. The spring 15 is positioned at a junction between the extrusions and the cuff 11. In a preferred embodiment the spring is a tightly wound coil of two wires, the ends of which extend into the cuff and the extrusions 13. When the extrusions are pressed together, the spring exerts force on the cuff wall, pulling opposing portions away from each other. This opposing force placed on the cuff pries the opening 12 apart, separating the gripping tongues. Thus, the clamp is an effective and easy to manipulate means for facilitating installation of the device.

In FIG. 3 there is shown a perspective view of the flag retention device in use. An exploded view of the basic embodiment of the device is shown attached to a flagpole. Several flag retention devices 10 are installed on a flag pole and used to hold multiple edges of a garden flag 17. The cuff 11 of the device encircles a portion of the support structure, such as the flag pole 16 or the horizontal extension pole 18. In the illustration these members form a T-shaped support structure for a sign or decorative flag, but other configurations are also contemplated.

The gripping tongues 14 of the installed cuffs face inward, toward the decorative flag 17. A portion of the edge of the flag is held firmly in place between the two gripping tongues. Multiple cuffs are used along two edges of the flag to restrict movement along those edges. By limiting the movement of the flag to only the outer two edges, the device prevents the flag from wrapping around the flag pole or horizontal extension during windy spells. In this way, the present invention reduces damage to outdoor décor and facilitates clearly visible messages and décor.

In use an individual pries the gripping jaws of the device apart and slides the cuff onto a support structure. This installation is accomplished by positioning the support structure between the gripping tongues and pressing the cuff forward until the support structure is positioned within the cuff interior. Next, the user selects an outdoor décor item such as a fabric flag, poster, sign, or the like. The user aligns the edges of the decorative item with the support structure, making sure that the image or message is properly displayed. Edges of the decorative item are then placed into between the gripping tongues. The gripping tongues are released after edge insertion, gripping the material between the tongues. This process is repeated with multiple flag retention devices until the décor item is properly restricted from movement.

The present invention is a compact, easy to use outdoor décor retention device. The cuff is available in a variety of sizes and geometrical cross-sections, to fit different types of support structures. Plastic, metal, or other rigid but slightly deformable materials may be used in the construction of the device. The device should return to its original shape when a user is not exerting force on the gripping tongues or clamp. The device may be used individually. But it is preferred that the retention devices are offered in a grouping, providing users with the ability to restrict the movement of multiple parts of the same decorative item.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device for retaining an outdoor décor item, comprising:
a cuff having at least one wall, said wall having an outer surface and inner surface and an upper and lower edge, and a single opening extending from said upper edge to said lower edge and between said inner and outer surface;
a pair of gripping tongues, said gripping tongues being panel extrusions having interior surfaces that snuggly abut when in a closed position, and wherein said tongues are disposed on either side of said opening in said cuff and extend in parallel away from said cuff;

2. The device of claim 1, wherein said cuff is cylindrical.

3. The device of claim 1, further comprising:
a clamp disposed on a portion of said cuff exterior surface;
said clamp comprised of two extrusions disposed at an angle of less than 180 degrees from one another, and a spring operatively connected to said extrusions and said cuff, such that compressing said extrusions inward toward each other results in an increase in interior diameter of said cuff and a widening of said cuff opening.

4. The device of claim 3, wherein said clamp is disposed on a portion of said cuff laterally opposing said gripping tongues.

5. An outdoor décor retention system, comprising:
a plurality of décor retainers;
each of said décor retainers having a cuff with at least one wall, said wall having an outer surface and inner surface and an upper and lower edge, and a single opening extending from said upper edge to said lower edge and between said inner and outer surface;
each of said décor retainers having a pair of gripping tongues, said gripping tongues being panel extrusions having interior surfaces that snuggly abut when in a closed position, and wherein said tongues are disposed on either side of said opening in said cuff and extend in parallel away from said cuff;

6. The outdoor décor retention system of claim 5, further comprising:
a clamp disposed on a portion of each of said cuff exterior surfaces;
said clamp comprised of two extrusions disposed at an angle of less than 180 degrees from one another, and a spring operatively connected to said extrusions and said cuff, such that compressing said extrusions inward toward each other results in an increase in interior diameter of said cuff and a widening of said cuff opening.

7. The system of claim 6, wherein said clamp is disposed on a portion of said cuffs laterally opposing said gripping tongues.
